(19) United States
(12) Patent Application Publication
(10) Pub. No.: US 2014/0216230 A1
(43) Pub. Date: Aug. 7, 2014

(54) Adjustable Zero Fret and Method of Use on a Stringed Instrument

(71) Applicant: Gibson Brands, Inc., Nashville, TN (US)

(72) Inventors: Frank Johns, Hermitage, TN (US); George Mathews, Mt Juliet, TN (US); John Steve Frensley, Lebanon, TN (US)

(21) Appl. No.: 14/092,181

(22) Filed: Nov. 27, 2013

Related U.S. Application Data
(60) Provisional application No. 61/731,026, filed on Nov. 29, 2012.

(51) Int. Cl. G10D 3/06

(52) U.S. Cl. CPC G10D 3/06
USPC 84/314 R

(57) ABSTRACT

An apparatus and method of varying the tonal aspects of a string instrument such as an acoustic or electric guitar which is commonly provided with a body and a fret board on the instrument's neck. The apparatus includes an upper portion and a lower portion. The lower portion is configured to connect with the fret board and to provide a base for the upper portion, The upper portion is configured to engage the lower portion. The upper portion is also configured to receive and support an instrument's strings. The upper portion is selectively movable relative to the lower portion by an operator to change the tonal nature of the instrument.

### CROSS-REFERENCE TO RELATED APPLICATIONS

The present application claims the benefit of U.S. Provisional Patent Application No. 61/731,026, titled Adjustable Zero Fret and Method of Use on a Stringed Instrument, filed on Nov. 29, 2012, the entire contents of which are all herein incorporated by reference and made a part hereof.

### FIELD OF THE INVENTION

The present invention relates to an adjustable zero fret device, and specifically to an adjustable zero fret device for use with stringed instruments.

### BACKGROUND

A zero fret is typically a fret-like device placed at the headstock end of the neck of a stringed instrument, such as, without limitation, a banjo, guitar, mandolin, or bass guitar. A function of the zero fret is that it holds the strings a desired distance above the other frets on the instrument's fret board. Typical zero frets are either static and therefore can't be adjusted to selectively modify the tonal quality of the instrument or overly complex in their construction and use.

An adjustable zero fret that is effective in modifying tonal quality and easy to use is desired.

### BRIEF DESCRIPTION OF THE DRAWINGS

FIG. 1 is an exploded isometric view of the adjustable zero fret assembly;

FIG. 2 is an isometric view of an upper portion of the adjustable zero fret assembly;

FIG. 3 is an isometric view of a lower portion of the adjustable zero fret assembly;

FIG. 4 is a top plan view of the upper portion of the adjustable zero fret assembly;

FIG. 5 is a frontal plan view of the upper portion of the adjustable zero fret assembly;

FIG. 6 is an end plan view of the upper portion of the adjustable zero fret assembly;

FIG. 7 is a top plan view of the lower portion of the adjustable zero fret assembly;

FIG. 8 is an end plan view of the lower portion of the adjustable zero fret assembly;

FIG. 9 is a top view of the adjustable zero fret assembly of FIG. 1 in use with a guitar; and,

FIG. 10 is a side view of the adjustable zero fret assembly of FIG. 1 in use with a guitar.

### DETAILED DESCRIPTION

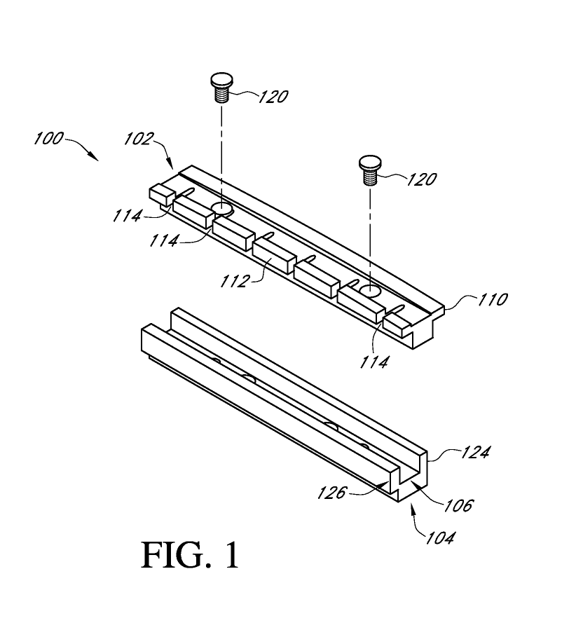

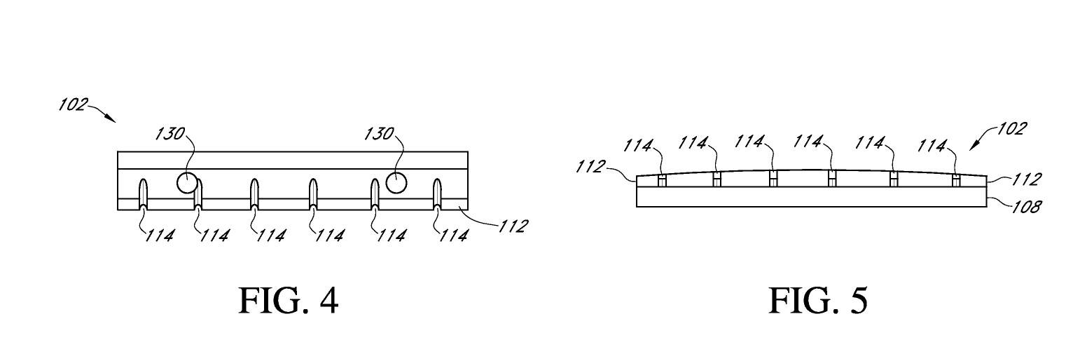

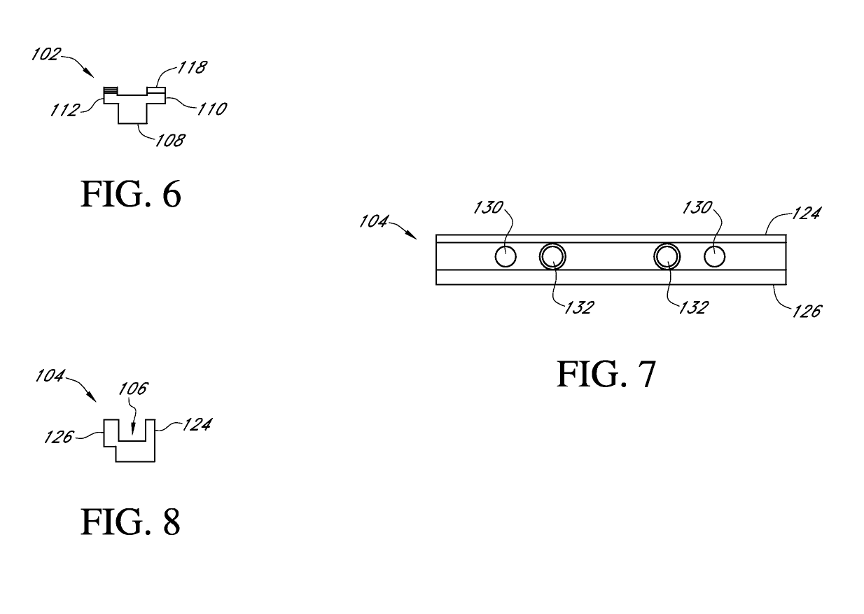

The device will now be described with reference to the accompanying Figures. In all Figures, like numerals Correspond to like elements. The device is directed to an apparatus and method for selectively modifying the tonal character of an acoustic or electric stringed instrument using an adjustable zero fret assembly. One suitable embodiment of an adjustable zero fret assembly, generally designated 100, is illustrated in FIGS. 1-9. Specific details of the device and its use are disclosed more completely below.

By way of background, the term “stringed instrument” is intended to be directed to a wide variety of stringed instruments. Suitable, non limiting examples include, acoustic guitar, electric guitar, acoustic bass guitar and electric bass guitar, banjo, mandolin, and similar type instruments. Although the Figures depict a six stringed instrument, the scope of this disclosure includes instruments with more or fewer strings.

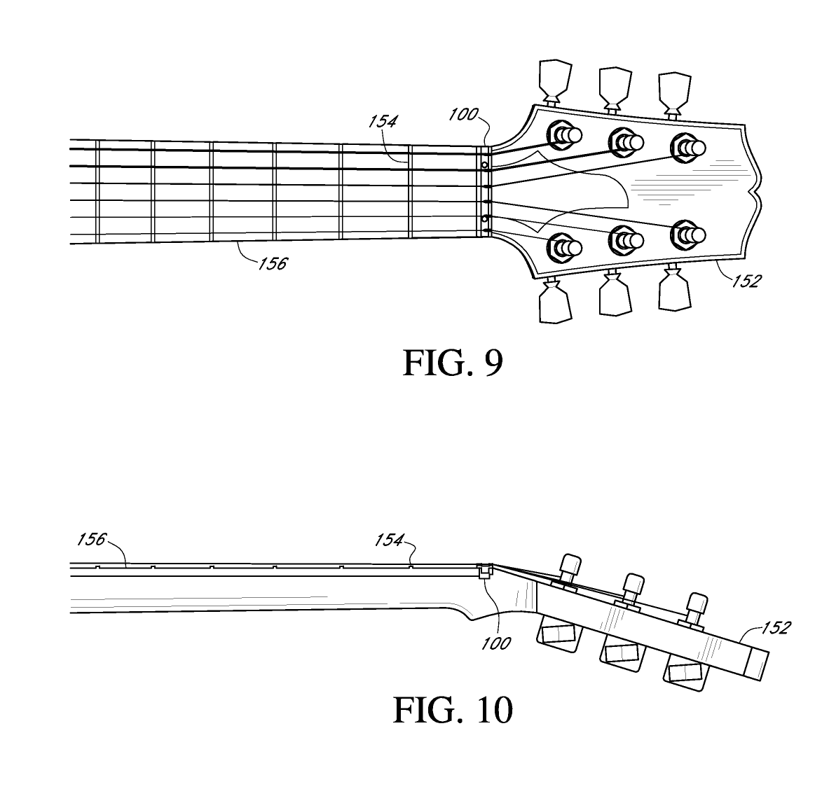

With specific reference to FIGS. 1-3, an adjustable fret assembly 100 is depicted. The adjustable fret assembly 100 includes a base portion 104 which is substantially an elongated U-shaped element. The base portion 104 includes a locator channel 106 defined by opposed parallel lower portion first support 124 and second lower second support 126. (best seen in FIGS. 3 and 7-8). The base portion 104 is generally configured to form a base element for the adjustable zero fret assembly 100. In use, the base portion 104 rest on the fret board or neck of a stringed instrument at a desired location best seen in FIGS. 9 and 10. In an embodiment, the base portion 104 includes at least one fastener bore 132 extending there through to enable the lower portion to be fixedly attached to the fret board or next of an instrument. Suitable fasteners include, without limitation, screws (not shown) or the like. Similarly, adhesives or other known fastening means may also be incorporated without exceeding the spirit and scope of this disclosure. In an alternative embodiment, the base portion does not include a fastener bore 132. In such instances the adjustable zero fret assembly 100 is held in place by the instrument's strings. In this manner, the adjustable zero fret assembly 100 may be removed easily and without harm to the instrument fret board or neck.

The adjustable zero fret assembly 100 also includes an adjustable portion 102. The adjustable portion 102 is a substantially elongated T-shaped element. The adjustable portion 102 includes a locator post 108 and opposed first flange portion 110 and second flange portion 112. The locator post 108 is configured to engage and, when in use, be positioned within the locator channel 106. It will be appreciated that the tolerance between the locator post 108 and the locator channel 106 will be such that the locator post 108 may be inserted and removed into the locator channel 106 as needed. However, once inserted, the tolerance between the two pieces will be such that any non user activated relative movement between the pieces is minimized or otherwise prevented.

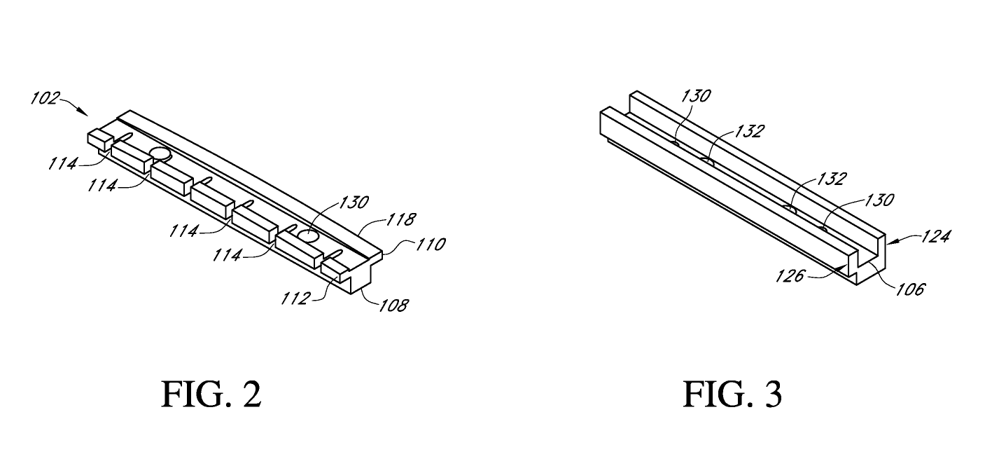

As best seen in FIGS. 2 and 4-6, the adjustable portion 102 includes opposed first flange portion 110 and second flange portion 112. The first flange portion 110 is configured with a number of seats 114. Each seat 114 is configured to receive one string of the instrument. As shown, the seats 114 are all the same size, however, the size and shape of the seats is variable. In an embodiment, the size, shape, spacing and general location of the seats 114 is based on the diameter of the instrument string and type of instrument. By way of non limiting example, the Figures depict a configuration as one might find used with a six string guitar.

The adjustable portion 102 also includes a second flange portion 112. The second flange portion 112 typically does not have any seats 114. However, it is considered within the scope of this disclosure to have a second flange portion that includes seats 114. (Not shown). The second flange portion typically does include a crown 116, although not necessarily. It will be appreciated that that crown 116 is configured to provide support for any strings passing over it, while limiting the contact surface area with the string so as to not adversely affect the tonal quality of the string or cause undue wear.

In operation, the base portion 104 is attached to the fret board 156 at, for example, a zero fret location. In one example, screws (not shown) are driven through the fastener bores 132 of the base portion 104 into the neck of the instrument. The adjustable portion 102 is positioned such that the locator post 108 is inserted into the locator channel 106. The adjustable portion 102 is held relative to the base portion 104 via adjustment fasteners 120 passing through the adjustable portion 102 and into the base portion 104. The adjustment fasteners 120 are configured to allow for very controlled user activated relative movement between the adjustable portion 102, the base portion 104, and when in use, the string 154. One suitable non limiting example of an adjustment fastener 120 of interest is a machine screw or the like. Strings may then be passed over the adjustable fret assembly 100 such that the strings are positioned of the seats. From there, the instrument may be strung as one normally would set up such an instrument.

The instrument may be tuned in a normal fashion if desired. Also, one non limiting unique aspect of this disclosure is that the tonal quality of the instrument may be selectively modified by engaging the adjustment fasteners 120 to either move the adjustable portion 104 closer to the base portion 104, or vice versa. In other words, in use, moving the adjustable portion 102 toward or away from the string 154. Thereby selectively modifying the length, tension, and diameter of the string 154 to modify tonal quality. It will be appreciated that as the adjustable portion 102 is moved relatively farther away from the base portion 104, the length of the string(s) is increased, and perhaps a corresponding decrease in string diameter, yielding a corresponding change of tonal quality. In this manner, a nearly infinite range of tonal values may be achieved.

For example, in one embodiment, the adjustment fasteners 120 are adjusted in the same direction equally such that the entire adjustable portion 102 is moved equidistance from the base portion 104 across the entire length of the adjustable portion 102. However, it is also within the scope of this disclosure that the adjustment fasteners 120 may be adjusted unequally, either in value or direction, such that a variable force is applied across a string group. In this manner, a user may match or correlate string properties (such as manufactured materials, size, shape, etc.) to a desired tonal quality simply by varying the adjustment fastener 120 settings.

With regard to material choices for the adjustable zero fret assembly 100, it will be appreciated that the bulk of the adjustable zero fret assembly 100 can be made of any suitably durable and hard material. Any variety of known metals, metal alloys, composites, bone, and suitable polymer based materials are within the scope of this disclosure provided they have adequate properties. Also, there may be selective materials choices, either for the device entirely or at selective positions of the adjustable zero fret assembly 100. For example, those portions of the seat 114 and/or crown 118 that contact the strings may be made of a material that matches or compliments the string choice while the remaining assembly 100 is constructed from another material. For example, a contact surface of the seat 114 may be made of the same or similar material as the outer surface of the string while the remaining assembly is of another material. In this manner, a user may achieve a desired tonal modification, while keeping such things as cost or weight within acceptable parameters. The selection and arrangement of the material choice is another unique aspect of this disclosure and is not intended to be a limiting factor.

With specific reference to FIGS. 9 and 10, one method of using the adjustable zero fret assembly 100 is depicted. In this particular, non limiting embodiment, the adjustable zero fret assembly 100 is shown in use with a guitar 150. As depicted, the adjustable zero fret assembly 100 is positioned adjacent the head stock 152. However, it will be appreciated that the positioning of the adjustable zero fret assembly 100 is variable dependent upon how a user prefers to use the device. Such placement of device shall not be limiting to the scope of this disclosure. Additionally, as discussed above, this device is not limited to a guitar 150, but rather to any stringed instrument.

In an embodiment of this disclosure, there is an adjustable zero fret assembly 100 for a stringed instrument The adjustable zero fret assembly 100 comprises a base portion 104, said base portion 104 defining a locator channel 106. The adjustable zero fret assembly 100 also comprises a single piece adjustable portion 104 selectively movable relative to said base portion 102; said single piece adjustable portion 104 including at least one seat port on 114 for receiving a string 154 of the stringed instrument. The at least one seat portion 114 having a contact surface 148.

In an embodiment, the adjustable zero fret assembly 100 is constructed from a material selected from at least one of a metal, metal alloy, composite, synthetic, ceramic, bone and polymer based material.

In an embodiment, the single piece adjustable portion is selectively moveable relative to the base portion via at least one threaded mechanical device.

In an embodiment, the threaded mechanical device is a machine screw.

In an embodiment, the at least one seat portion is constructed from a material that is different than the remaining portions of the single piece adjustable portion.

In an embodiment, a method of varying the tonal quality of a stringed instrument is provided. This method includes providing a stringed instrument having at least two strings 154 configured to produce a tonal sound. The stringed instrument having an initial tonal quality, The method further includes providing an adjustable zero fret assembly 100 adjacent the at least two strings 154, said adjustable zero fret assembly 100 including a base portion 104 and a single piece adjustable portion 102, the single piece adjustable portion 102 being selectively moveable relative to the base portion 104. The method also includes providing a biasing force to the at least two strings 154 by selectively moving the single piece adjustable portion 102 in a direction toward or away from the at least two strings 154.

In an embodiment, the method includes the single piece adjustable portion being selectively moveable relative to the base portion via at least one threaded mechanical device.

In an embodiment, the method includes the threaded mechanical device being a machine screw.

While various aspects of this disclosure have been illustrated and described, it will be appreciated that various changes can be made therein without departing from the spirit and scope of this disclosure. For example, without limitation, the base portion 104 and the adjustable portion 102 do not necessarily need to be substantially U-shaped and T-shaped, respectively. Other geometries may be used. Additionally, there may be more or fewer than the two adjustment fasteners 120 used to control movement of the adjustable portion 102 relative to the base portion 104. Further, other variations and modifications apparent to those skilled in the art may be made within the nature of this disclosure.

What is claimed is:

1. An adjustable zero fret assembly for a stringed instrument, comprising:
(a) a base portion, said base portion defining a locator channel; and
(b) a single piece adjustable portion selectively movable relative to said base portion; said single piece adjustable portion including at least one seat portion for receiving a string of the stringed instrument, said at least one seat portion having a contact surface.

2. A method of varying the tonal quality of a stringed instrument, comprising:
(a) providing a stringed instrument having at least two strings playable to produce a tonal sound, said stringed instrument having an initial tonal quality;
(b) providing a two piece adjustable zero fret assembly adjacent the at least two strings, said two piece adjustable zero fret assembly including a base portion and a single piece adjustable portion, the single piece adjustable portion being selectively moveable relative to the base portion; and,
(c) providing a biasing force to the at least two strings by selectively moving single piece adjustable portion in a direction toward or away from the at least two strings.
